(19) United States
(12) Patent Application Publication
(10) Pub. No.: US 2013/0058641 A1
(43) Pub. Date: Mar. 7, 2013

(54) CAMERA MIRROR

(71) Applicant: Thomas Phillips, Princeton, IL (US)

(72) Inventor: Thomas Phillips, Princeton, IL (US)

(21) Appl. No.: 13/225,442

(22) Filed: Sep. 3, 2011

(51) Int. Cl. G03B 15/00

(52) U.S. Cl. 396/544

(57) ABSTRACT

A Posing Mirror for Cameras that attaches directly to the lens adaptor portion of the lens housing of a camera providing a sturdy fitting and being round is free to turn as the lens adaptor portion of the camera turns during focusing. The mirror being round and of little weight allows it to turn quickly with no affect which is especially useful with EOS type lenses which turn quickly and automatically during autofocus.

### CROSS REFERENCE TO RELATED APPLICATIONS

PROVISIONAL PATENT APPLICATION NO. 61/399,464 (for ref only) Filing date: Jul. 7, 2010

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

The subject of this invention pertains to the attachment of a mirror to a camera for the purpose of a person having their photograph taken to pose in. The idea of placing a mirror in front of a camera for a person to pose in has been around many years. The difference between this and previous methods is that the mirror attachment becomes like a part of the camera and if the user decides to leave it on, he, or she may do so without affecting the use of the camera substantially. The mirror is small enough in size so that it may be packed into a normal camera bag while attached to the camera and yet large enough to perform it's intended function well.

This invention uses a round mirror which is thin and light weight; similar in shape to a CD or DVD with a hole in the center being sized to allow a standard lens filter or extension ring male thread end to be inserted through it and when this male thread is then screwed into the female thread on the camera lens housing the flange on the extension ring clamps the mirror to the front of the camera lens housing.

In assembly the mirror is allowed to turn as the camera lens turns during focusing and the mirror stays stationary relative to the camera lens. In particular, with EOS lenses, a popular lens assembly that focuses automatically, this makes the idea workable as the lens turns quickly during auto focus.

The size being likely to be that of a CD or DVD record has to do with containers available to put the mirror in when not being used and this coincidentally being a suitable size for posing purposes and allows for the camera flash feature not to be blocked when used.

### BRIEF SUMMARY OF THE INVENTION

It is an object of this invention to provide a means of taking portraits with a single lens reflex camera that provides the subject having his or her, portrait taken a mirror image of what the camera sees enabling them to change their facial expression to one they would prefer to have in a picture. This is accomplished by a mirror that may be roughly the size of a compact disc with a hole through the center in it that allows a common uv lens filter or extension ring to go through sandwiching said mirror between the flat surface of the lens housing of said uv lens filter or extension ring and the end surface of the lens casing on the camera lens assembly. Said mirror being round allows it to turn as the camera is focused without appearing out of position or creating a distraction and said mirror being thin allows it to be attached with a common uv filter. Said mirror being light weight allows it to turn without damaging an EOS type automatically focusing lens assembly.

### BRIEF DESCRIPTION OF THE SEVERAL VIEWS OF THE DRAWING

FIG. 1 is an orthographic view of the mirror attached to the camera.

FIG. 2 is an orthographic view of the mirror uv filter and mirror in alignment but exploded apart.

FIG. 3 is an orthographic view of the mirror attached to the camera with a subject looking into the mirror.

### DETAILED DESCRIPTION OF THE INVENTION

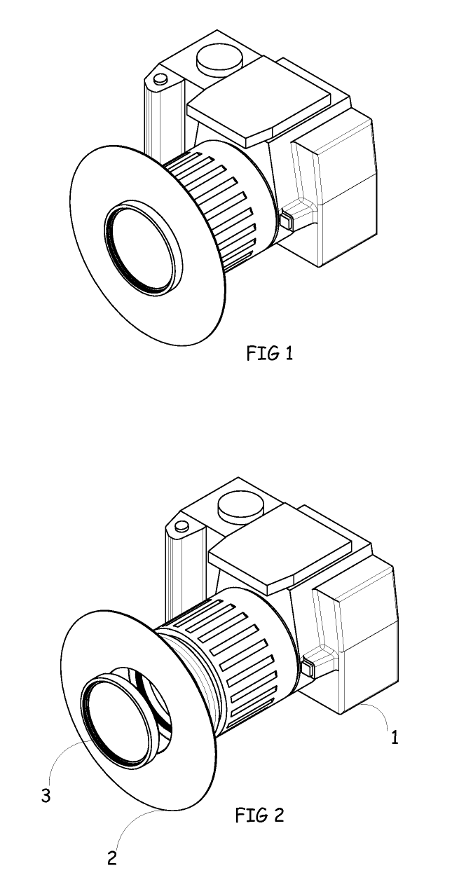

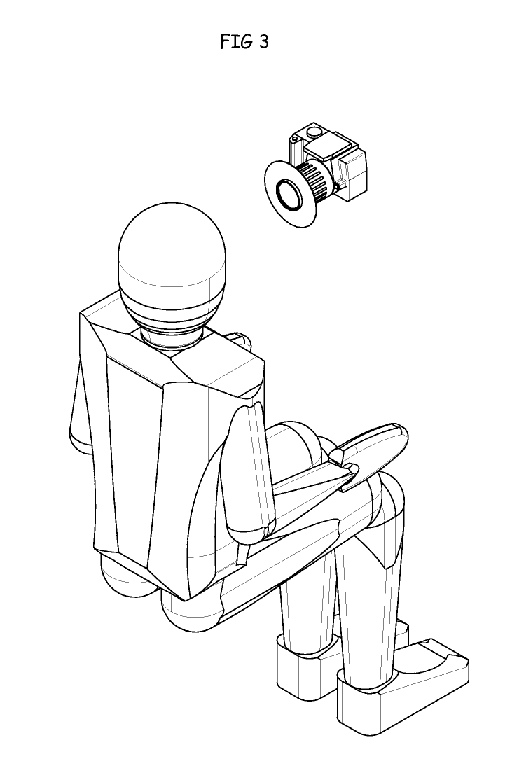

Referring to FIG. 1 an slr camera with a mirror attached is shown. Referring to FIG. 2, the Camera 1, the Mirror 2, and the UV Filter 3 are shown separately. To assemble, the UV Filter 3 is screwed onto the lens adaptor portion of the camera with the Mirror 2 between it and the lens of the camera. Those familiar with slr cameras will know that lens adaptor threads come in various sizes; 52 mm and 49 mm being common sizes. In the case of a 52 mm lens adaptor the camera lens will have a 52 mm female thread and the UV Filter 3 a matching male thread and the Mirror 2 will have a hole through it's center just large enough for the 52 mm male thread on the UV Filter 3 to go through but small enough that the flat surface on the UV Filter beyond the said thread will not go through. Therefore when the threaded portion of the UV Filter or Extension Ring is inserted through the hole in the mirror and screwed into the camera lens thread the mirror is clamped to the front of the camera lens housing.

Another feature that may be useful in handling is as follows. The size of the hole in the mirror is such that a threaded Extension Ring or UV Filter can be inserted through it. A problem with this assembly is that when the Extension Ring or UV Filter is unscrewed from the camera the Mirror 2, and Extension Ring 3 are free to fall apart. A method to keep them together may be provided by the incorporation of small projections to the inside diameter of the Mirror. The Mirror stock being thin these small projections would enter the thread on said Extension Ring enough to keep the Mirror and Extension Ring together when not attached to the camera. Another method of course would be to simply use adhesive or another method to simply leave them as separate components.

1. (canceled)

2. (canceled)

3. (canceled)

4. In a camera having a lens within a lens housing attached to a camera and having a threaded inside diameter at the open end into which is screwed a clear lens protector having a flange beyond the threaded portion that butts against the front of said lens housing when screwed in;
a round reflective mirror with a hole through the center such that when the threaded portion of said clear lens protector is inserted through it and then screwed into the threaded portion of said lens housing said round reflective mirror is held securely between said flange and the front surface of said lens housing providing a mirror for a subject having their picture taken to pose in.

5. The round reflective mirror in claim 4 in which said mirror is sized to fit within a standard CD or DVD disk case.

6. The round reflective mirror in claim 4 in which one or more substantially small projections inward are made on the inside diameter of the hole through said mirror; said mirror being thin enough and said projections small enough that they will fit within the threads of the threaded portion of said lens protector such that the mirror can be screwed onto said lens protector.
